(19) United States
(12) Patent Application Publication
(10) Pub. No.: US 2023/0407045 A1
(43) Pub. Date: Dec. 21, 2023

(54) PVC Compositions Containing Rare Earth Additive

(71) Applicant: Neo Chemicals & Oxides, LLC, Greenwood Village, CO (US)

(72) Inventors: Steven P. Williams, Oxfordshire (GB); Mason Reames Haneline, Orange, CA (US); Mariusz Kiszka, Warsaw (PL); Camillo Cardelli, San Guiliano (IT); Sara Haveriku, Pisa (IT); Marco Badalassi, Sansepolcro (IT)

(73) Assignee: Neo Chemicals & Oxides, LLC, Greenwood Village, CO (US)

(21) Appl. No.: 18/338,196

(22) Filed: Jun. 20, 2023

Related U.S. Application Data
(60) Provisional application No. 63/353,445, filed on Jun. 17, 2022.

(51) Int. Cl. C08K 3/22

(52) U.S. Cl. CPC C08K 3/2279; C08K 3/22; C08K 2003/221; C08K 2003/2224; C08K 2201/014

(57) ABSTRACT

PVC compositions disclosed herein comprise PVC resin, a rare earth compound, and an inorganic flame retardant. These PVC compositions demonstrate an improved flame retardance and have UL94 classification with a sample thickness of about 0.8 mm of V-2 or higher. The rare earth compound can be rare earth hydroxides, hydrated rare earth oxides, and mixtures thereof. The inorganic flame retardant can be antimony trioxide (ATO), magnesium dihydroxide (MDH), aluminum trihydrate (ATH), and mixtures thereof. The combination of the rare earth compound and inorganic flame retardant forms a synergistic partnership.

### RELATED APPLICATION

This application claims priority to and benefit of U.S. Provisional Application No. 63/353,445 filed Jun. 17, 2022, the contents of which are hereby incorporated by reference in their entirety.

### FIELD OF THE INVENTION

The invention relates to a polyvinyl chloride (PVC) compositions containing PVC resin, an inorganic flame retardant, and a rare earth compound, wherein the PVC compositions have a UL94 classification with a sample thickness of about 0.8 mm of V-2 or higher/better. The rare earth compound improves performance of the inorganic flame retardant additive and/or the flame retardant properties and thermal stability of the PVC formulation.

### INTRODUCTION

Polyvinyl chloride (PVC) resin is a polymer made from vinyl chloride monomer. This resin is mixed with other components to make a PVC composition or formulation which is often referred to simply as PVC. These PVC compositions require specific properties such as flame retardancy, color, thermal stability, malleability and moldability, to name a few. The other components or additives in the composition can impart the desired properties and these components/additives can be categorized as plasticizers, stabilizers, lubricants, fillers, and other functional additives. The amount of each of these additional components/additives also can change the desired properties of the PVC composition.

PVC compositions and products made from these PVC compositions generate hydrogen chloride gas during high shear processing or as a direct result of a combustion event, which can corrode external appliances and auto-initiates further decomposition of the PVC. Antimony trioxide (ATO), magnesium dihydroxide (MDH), and aluminum trihydrate (also frequently called alumina trihydrate (ATH)) have been used as flame retardants in PVC compositions. However, ATO is considered highly toxic and produces a large degree of smoke during a combustion event. The utility of ATH and MDH can be limited by their compatibility with particular PVC compositions, and ATH and MDH can have relatively limited loading capacity before negatively affecting physical and aesthetic characteristics of the PVC compositions and end-use products. Reducing or eliminating the content of these flame retardants in favor of “green” additives would be a significant advantage and remains a challenge.

Other typical examples of flame retardant additives include halogenated organic compounds, such as halogenated paraffins. These additives also are not considered “environmentally friendly” and in some jurisdictions, such as within Europe, are banned from use.

Accordingly, there remains a need for additives for PVC compositions that impart synergistic effects with known flame retardants and/or additional thermal stability. It is desirable to reduce the amount of ATO because of its toxicity, while providing a synergistic flame retardant additive and/or thermal stabilizer and/or acid scavenger and/or smoke suppressant (reduces smoke density, release & acidity) for PVC compositions. This desired additive should have excellent dispersibility in polymer and thermoplastic resin compositions and can be used to prepare flame-retardant and plasticized PVC compositions with excellent flame retardant and mechanical properties.

### SUMMARY

In one embodiment, disclosed herein is a polyvinyl chloride (PVC) composition comprising: PVC resin; an inorganic flame retardant selected from the group consisting of antimony trioxide (ATO), magnesium dihydroxide (MDH), aluminum trihydrate (ATH), and mixtures thereof; and a rare earth compound selected from the group consisting of rare earth hydroxides, hydrated rare earth oxides, and mixtures thereof. This PVC composition comprises 100 phr of PVC resin and has a UL94 classification with a sample thickness of about 0.8 mm of V-2 or higher. In certain embodiments, this PVC composition has a UL94 classification with a sample thickness of 0.8 mm of V-0.

In certain embodiments, the rare earth compound is yttrium hydroxide, lanthanum hydroxide, cerium hydroxide, neodymium hydroxide, praseodymium hydroxide, hydrated yttrium oxide, hydrated lanthanum oxide, hydrated cerium oxide, hydrated neodymium oxide, hydrated praseodymium oxide, or mixtures thereof, and in particular embodiments, the rare earth compound is yttrium hydroxide, lanthanum hydroxide, or a mixture thereof.

The combination of the rare earth compound and inorganic flame retardant forms a synergistic partnership. As such, the PVC compositions including the rare earth compound contain an amount of inorganic flame retardant that is less than would be required in the absence of the rare earth compound to achieve the desired flame retardant properties (i.e., a UL94 classification with a sample thickness of about 0.8 mm of V-2 or higher/better). As such, the PVC compositions, including the rare earth compound, are able to contain less inorganic flame retardant in comparison to identical PVC compositions not containing the rare earth compound and achieve the same UL94 classification (i.e., a UL94 classification with a sample thickness of about 0.8 mm of V-2 or higher/better and in some embodiments a UL94 classification with a sample thickness of about 0.8 mm of V-0).

In another embodiment, a PVC composition comprises: PVC resin; ATO; and a rare earth hydroxide comprising Y(OH)₃, La(OH)₃, or a mixture thereof. This PVC composition comprises 100 phr of PVC resin and comprises ATO and rare earth hydroxide collectively in an amount of about 3 phr to about 10 phr. This PVC composition has a UL94 classification with a sample thickness of 0.8 mm of V-0, V-1, or V-2 and contains less ATO than in an identical PVC composition not containing the rare earth hydroxide to achieve the same UL94 classification. In certain of these embodiments, this PVC composition has a UL94 classification with a sample thickness of 0.8 mm of V-0.

In specific of these embodiments, this PVC composition comprises about 0 phr chlorinated paraffins.

In yet another embodiment disclosed herein is a PVC composition comprising: 100 phr PVC resin; about 25 phr to about 50 phr MDH; and about 3 phr to about 10 phr rare earth hydroxide, wherein the rare earth hydroxide comprises Y(OH)₃, La(OH)₃, or a mixture thereof. This PVC composition has a UL94 classification with a sample thickness of 0.8 mm of V-0, V-1, or V-2. In certain embodiments, this PVC composition has a UL94 classification with a sample thickness of 0.8 mm of V-0.

In addition, in certain of these embodiments with MDH and rare earth compound, the PVC composition is able to contain about zero phr (i.e., no) ATO and have a desirable UL94 classification (i.e., a UL94 classification with a sample thickness of about 0.8 mm of V-2 or higher/better and in some embodiments a UL94 classification with a sample thickness of about mm of V-0).

### BRIEF DESCRIPTION OF THE DRAWINGS

FIG. 1 is a graph illustrating the thermogravimetric analysis of the yttrium hydroxide as synthesized in Example 1.

FIG. 2 is a Differential Scanning calorimetry of the yttrium hydroxide as synthesized in Example 1 over temperature range relevant for flame retardancy.

### DETAILED DESCRIPTION

Before the compositions, articles, and methods are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a rare earth compound” or “an inorganic fire retardant” is not to be taken as quantitatively or source limiting, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” or “approximately” include typical experimental variances. As used herein, the terms “about” and “approximately” are used interchangeably and mean within a statistically meaningful range of a value, such as a stated weight percentage, surface area, concentration range, time frame, distance, molecular weight, temperature, pH, and the like. Such a range can be within an order of magnitude, typically within 10%, and even more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, at least every whole number integer within the range is also contemplated as an embodiment of the invention.

Polyvinyl chloride (PVC) resin is a polymer made from vinyl chloride monomer, and this resin is mixed with other components to make PVC compositions or formulations. These PVC compositions or formulations are used in end-use PVC products.

It is noted that the terms flame and fire are used interchangeably herein in describing the properties of the PVC composition and in describing the additives imparting these properties to the PVC.

ATH interchangeably can be referred to as alumina trihydrate, aluminum trihydrate, or aluminum trihydroxide and in describing this additive, these names can be used interchangeably to mean the same.

The present disclosure relates to polyvinyl chloride (PVC) compositions having desirable properties, including flame retardancy and good thermal stability. The PVC compositions as disclosed herein can be in rigid and flexible forms. The disclosed PVC compositions contain PVC resin, an inorganic flame retardant, and a rare earth compound. The inorganic flame retardant of these compositions can be antimony trioxide (ATO), magnesium dihydroxide (MDH), aluminum trihydrate (ATH), or mixtures thereof. The rare earth compound of these compositions can be rare earth hydroxides, hydrated rare earth oxides, or mixtures thereof.

As such, the PVC compositions can comprise a PVC resin; an inorganic flame retardant selected from the group consisting of antimony trioxide (ATO), magnesium dihydroxide (MDH), aluminum trihydrate (ATH), and mixtures thereof and a rare earth compound selected from the group consisting of rare earth hydroxides, hydrated rare earth oxides, and mixtures thereof, wherein the composition comprises 100 phr of PVC resin.

Without being bound by the theory, it is believed that combination of the rare earth compound and inorganic flame retardant are a synergistic partnership. As such, the PVC compositions including the rare earth compound contain an amount of inorganic flame retardant that is less than would be required in the absence of the rare earth compound and achieve the desired flame retardant properties (i.e., a UL94 classification with a sample thickness of about 0.8 mm of V-2 or higher/better). The PVC compositions including the rare earth compound are able to contain less inorganic flame retardant in comparison to identical PVC compositions not containing the rare earth compound and achieve the same UL94 classification (i.e., a UL94 classification with a sample thickness of about 0.8 mm of V-2 or higher/better, and in some embodiments, a UL94 classification with a sample thickness of about 0.8 mm of V-0).

As described above, the inorganic flame retardant of these compositions is antimony trioxide (ATO), magnesium dihydroxide (MDH), aluminum trihydrate (ATH), or mixtures thereof. The inorganic flame retardants may be present in an amount of about 1 phr to about 60 phr within the PVC composition. The PVC industry is interested in PVC compositions in which the amount of these inorganic flame retardants (in particular ATO) is minimized while still achieving the desired flame retardancy and thermal stability.

In certain embodiments, the inorganic flame retardant is antimony trioxide (ATO). As such, in certain embodiments the PVC compositions contain ATO. Through the combination of the rare earth compound and ATO, the PVC composition is able to contain less ATO than in an identical PVC composition not containing the rare earth compound and achieve the same UL94 classification (i.e., a UL94 classification with a sample thickness of about 0.8 mm of V-2 or higher/better, and in some embodiments, a UL94 classification with a sample thickness of about 0.8 mm of V-0). ATO is a highly effective flame retardant; however, it is considered highly toxic and produces a large degree of smoke during a combustion event. Thus, minimizing the amount of ATO required to achieve a PVC composition with acceptable flame retardancy and thermal stability is a significant advantage.

In the disclosed PVC compositions when the inorganic fire retardant is ATO, it is generally present in an amount of about 1 phr to about 6 phr.

In certain embodiments, the inorganic flame retardant is MDH. As such, in certain embodiments the PVC compositions contain MDH. When the inorganic fire retardant is MDH, it is generally present in an amount of about 15 phr to about 50 phr. In certain embodiments containing MDH, the PVC composition contains about 25 phr to about 50 phr MDH. In other embodiments containing MDH, the PVC composition contains about 30 phr to about 50 phr MDH. The utility of MDH can be limited by its compatibility with particular PVC compositions, and MDH can have relatively limited loading capacity before negatively affecting physical and aesthetic characteristics of the PVC product. Through the combination of the rare earth compound and MDH, the PVC composition is able to contain less MDH than in an identical PVC composition not containing the rare earth compound and achieve the same UL94 classification (i.e., a UL94 classification with a sample thickness of about 0.8 mm of V-2 or higher/better, and in some embodiments, a UL94 classification with a sample thickness of about 0.8 mm of V-0). In addition, in certain of these embodiments with MDH and rare earth compound, the PVC composition is able to contain about zero phr (i.e., no) ATO and have a desirable UL94 classification (i.e., a UL94 classification with a sample thickness of about 0.8 mm of V-2 or higher/better, and in some embodiments, a UL94 classification with a sample thickness of about mm of V-0).

In other embodiments, the inorganic flame retardant is ATH. As such, in certain embodiments the PVC compositions contain ATH. When the inorganic flame retardant is ATH, it is generally present in an amount of about 15 phr to about 50 phr. In certain embodiments containing ATH, the PVC composition contains about 25 phr to about 50 phr MDH. In other embodiments containing ATH, the PVC composition contains about 30 phr to about 50 phr MDH. The utility of ATH can be limited by its compatibility with particular PVC compositions, and ATH can have relatively limited loading capacity before negatively affecting physical and aesthetic characteristics of the PVC product. Through the combination of the rare earth compound and ATH, the PVC composition is able to contain less ATH than in an identical PVC composition not containing the rare earth compound and achieve the same UL94 classification (i.e., a UL94 classification with a sample thickness of about 0.8 mm of V-2 or higher/better, and in some embodiments, a UL94 classification with a sample thickness of about 0.8 mm of V-0). In addition, in certain of these embodiments with ATH and rare earth compound, the PVC composition is able to contain about zero phr (i.e., no) ATO and have a desirable UL94 classification (i.e., a UL94 classification with a sample thickness of about 0.8 mm of V-2 or higher/better, and in some embodiments, a UL94 classification with a sample thickness of about mm of V-0).

In other embodiments, the inorganic flame retardant is a mixture of ATO and MDH and/or ATH. When the inorganic flame retardant is a mixture of MDH and/or ATH with ATO, the mixture is present in an amount of about 16 phr to about 56 phr. Through the combination of the rare earth compound with this mixture of inorganic flame retardant, the PVC composition is able to contain less ATO than in an identical PVC composition not containing the rare earth compound and achieve the same UL94 classification (i.e., a UL94 classification with a sample thickness of about 0.8 mm of V-2 or higher/better, and in some embodiments, a UL94 classification with a sample thickness of about 0.8 mm of V-0).

The present PVC compositions exhibit desirable and necessary flame retardancy for the end-uses of the PVC composition, while allowing for reduced amounts of these inorganic flame retardants (and in particular ATO) through the addition of a rare earth compound to the composition. The present PVC compositions also exhibit desirable and necessary thermal stability for the end-uses of the PVC compositions, while allowing for reduced amounts of these inorganic flame retardants through the addition of a rare earth compound to the composition.

As disclosed above, the rare earth compounds comprise rare earth hydroxides, hydrated rare earth oxides, or mixtures thereof. The rare earth of these compounds is yttrium (Y), lanthanum (La), neodymium (Nd), praseodymium (Pr), samarium (Sm), europium (Eu), gadolinium (Gd), terbium (Tb), dysprosium (Dy), holmium (Ho), erbium (Er), thulium (Tm), ytterbium (Yb), lutetium (Lu), cerium (Ce), or mixtures thereof. In certain embodiments, the rare earth is yttrium (Y), lanthanum (La), neodymium (Nd), praseodymium (Pr), samarium (Sm), or mixtures thereof. In particular embodiments, the rare earth compound can comprise a yttrium compound (hydroxide and/or hydrated rare earth oxide), lanthanum compound (hydroxide and/or hydrated rare earth oxide), cerium compound (hydroxide and/or hydrated rare earth oxide), or mixtures thereof.

In certain embodiments, the rare earth compound is yttrium hydroxide, lanthanum hydroxide, cerium hydroxide, neodymium hydroxide, praseodymium hydroxide, hydrated yttrium oxide (e.g., Y₂O₃⋅3H₂O), hydrated lanthanum oxide (e.g., La₂O₃⋅3H₂O), hydrated cerium oxide (e.g., CeO₂⋅2H₂O), hydrated neodymium oxide (e.g., Nd₂O₃⋅3H₂O), hydrated praseodymium oxide (e.g., Pr₂O₃⋅3H₂O), or mixtures thereof. In specific embodiments, the rare earth compound is yttrium hydroxide, lanthanum hydroxide, cerium hydroxide, hydrated yttrium oxide (Y₂O₃⋅3H₂O), hydrated lanthanum oxide (La₂O₃⋅3H₂O), hydrated cerium oxide (CeO₂⋅2H₂O), or mixtures thereof .In yet additional embodiments, the rare earth compound is Y(OH)₃, Y₂O₃⋅3H₂O, or mixtures thereof. In other additional embodiments, the rare earth compound is Y(OH)₃, Y₂O₃⋅3H₂O, La(OH)₃, La₂O₃⋅3H₂O, or mixtures thereof. In further embodiments, the rare earth compound is yttrium hydroxide, lanthanum hydroxide, or mixtures thereof.

In these embodiments of the above particularly recited rare earth compounds, the rare earth compounds additionally may contain minor amounts of any other rare earth hydroxides or hydrated rare earth oxides. Rare earth compounds commonly exist as mixtures. In certain embodiments, the above particularly recited rare earth compounds additionally may contain minor amounts of neodymium (Nd) and/or samarium (Sm) hydroxides or hydrated oxides. When present in minor amounts, these minor amounts are typically less than 5% by weight or trace amounts.

In some embodiments, the particle size of the rare earth compounds allows these compounds to be more readily incorporated into the PVC composition. In these embodiments, the rare earth compound can have a particle size of less than 10 microns. In certain of these embodiments, the rare earth compounds have a particle size of about 0.1 microns to about 10 microns. If necessary, the particle size distribution can be altered by milling and separation processes to generate a more uniform particle size distribution. The particle size as described herein is measured using a Malvern Mastersizer 2000. This particle size can be combined with any of the particularly recited embodiments of the rare earth compounds.

In the PVC compositions as disclosed herein, the rare earth compounds may be present in an amount of about 1 phr to about 10 phr. In certain embodiments, the rare earth compounds may be present in an amount of about 1 phr to about 6 phr. These amounts of rare earth compounds can be combined with any of the particularly recited embodiments of the rare earth compounds.

As described herein, the addition of these rare earth compounds to the PVC compositions allow the PVC compositions to exhibit desirable and necessary flame retardancy, while allowing for reduced amounts of these inorganic flame retardants (and in particular ATO). As such, the PVC compositions as disclosed herein contain reduced amounts of these inorganic flame retardants (and in particular ATO) while achieving the same UL94 classification (i.e., a UL94 classification with a sample thickness of about 0.8 mm of V-2 or higher/better, and in some embodiments, a UL94 classification with a sample thickness of about 0.8 mm of V-0) as an identical PVC composition not containing the rare earth compounds.

Within the PVC compositions, it is believed that the rare earth compounds comprising rare earth hydroxides, hydrated rare earth oxides, or mixtures thereof herein release coordinated water species at processing temperatures exceeding 200° C. These rare earth compounds have an ability to hold on to water at high temperatures. Without being bound by the theory, the release of water can cool and dilute the combustion process of the PVC composition and/or end-use PVC product. In particular for PVC wiring, the release of water in the 200-600° C. temperature range is advantageous. The endothermic reaction results in the formation of an oxide layer which acts as an insulating barrier, inhibiting the release of gases that can contribute to pyrolysis of the PVC. Without being bound, the thermal stabilization properties of the rare earth compounds in PVC delays the release of corrosive HCl and is a key attribute to their surprising desirability in the PVC compositions.

The disclosed PVC compositions exhibit desirable and necessary flame retardancy measured and determined by UL94 classification. UL94 is a plastics flammability standard released by the Underwriters Laboratories (USA). The standard classifies plastics according to how they burn in various orientations and thicknesses from the lowest flame-retardant to most flame-retardant in six different classifications. The PVC compositions as disclosed herein have a UL94 classification with a sample thickness of about 0.8 mm of V-2 or higher/better. In some embodiments, the PVC compositions as disclosed herein have a UL94 classification with a sample thickness of about 0.8 mm of V-0.

TABLE 1
UL94 classifications

| | | | Time of | Particle drop allowed | | |
|---|---|---|---|---|---|---|
| UL94 | Orientation | | Burn | | Non- | Plaque |
| Classification | of sample | Definition | Allowed | Flaming | Flaming | holes |
| HB | Horizontal | Slow | | | | |
| | | burning | | | | |
| V-2 | Vertical | Burning | 30 sec | Yes | Yes | |
| | | stops | | | | |
| V-1 | Vertical | Burning | 30 sec | No | Yes | |
| | | stops | | | | |
| V-0 | Vertical | Burning | 10 sec | No | Yes | |
| | | stops | | | | |
| 5VB | Vertical | Burning | 60 sec | No | No | Yes |
| | | stops | | | | |
| 5VA | Vertical | Burning | 60 sec | No | No | No |
| | | stops | | | | |

In certain embodiments, the PVC compositions as disclosed herein have a UL94 classification with a sample thickness of about 0.8 mm of V-2, V-1, or V-0. In specific embodiments, the PVC compositions as disclosed herein have a UL94 classification with a sample thickness of about 0.8 mm of V-0.

The PVC compositions as disclosed herein contain 100 phr of PVC resin. The inorganic flame retardant(s) and rare earth compound(s) are added to this PVC resin as additives and provide the PVC composition. This PVC composition can be used in a variety of end-use PVC products. As described above, the inorganic flame retardant and rare earth compound interact in a synergistic manner such that the PVC composition contains a reduced amount (in phr) of inorganic flame retardant than is typically required to achieve the UL94 classification with a sample thickness of about 0.8 mm of V-2 or higher/better. In certain embodiments, the PVC composition also can have a CongoRed at 200° C. of about 90 mins to about 200 mins.

As such, the PVC compositions containing the rare earth compounds contain reduced amounts of these inorganic flame retardants (and in particular ATO) while achieving the same UL94 classification (i.e., a UL94 classification with a sample thickness of about 0.8 mm of V-2 or higher/better, and in some embodiments, a UL94 classification with a sample thickness of about mm of V-0) as an identical PVC composition not containing the rare earth compounds.

The polyvinyl chloride (PVC) compositions disclosed herein comprise PVC resin; an inorganic flame retardant selected from the group consisting of antimony trioxide (ATO), magnesium dihydroxide (MDH), aluminum trihydrate (ATH), and mixtures thereof; and a rare earth compound selected from the group consisting of rare earth hydroxides, hydrated rare earth oxides, and mixtures thereof; wherein the composition comprises 100 phr of PVC resin and has a UL94 classification with a sample thickness of about 0.8 mm of V-2 or higher/better. In certain embodiments the PVC composition has a UL94 classification with a sample thickness of about mm of V-0.

Traditional PVC compositions containing ATO as an inorganic fire retardant, contain more ATO than the amount of ATO that is required in the present PVC compositions to achieve the UL94 classification. Containing less ATO is advantageous because ATO is considered highly toxic. In the PVC compositions disclosed herein, the amount of ATO is reduced while achieving the same UL94 classification. In embodiments of the PVC composition wherein the inorganic flame retardant is ATO, the ratio of ATO to rare earth compound can be about 1:3 to about 3:1. In certain of these embodiments the rare earth compound comprises yttrium hydroxide, lanthanum hydroxide, or mixtures thereof. In other embodiments, the ratio of ATO to rare earth compound is about 1:1. In certain of these embodiments the rare earth compound comprises yttrium hydroxide, lanthanum hydroxide, or mixtures thereof. In additional embodiments, the ratio of ATO to rare earth compound can be about 1:1 to about 1:3. In certain of these embodiments the rare earth compound comprises yttrium hydroxide, lanthanum hydroxide, or mixtures thereof.

In certain embodiments where the inorganic flame retardant is ATO, the PVC composition collectively can comprise about 3 phr to about 10 phr of ATO and rare earth compound. In certain of these embodiments the rare earth compound comprises yttrium hydroxide, lanthanum hydroxide, or mixtures thereof. In specific embodiments, the PVC composition can comprise about 1 to about 3.5 phr ATO and about 1 to about 3.5 phr rare earth compound, and in certain of these embodiments the rare earth compound comprises yttrium hydroxide, lanthanum hydroxide, or mixtures thereof. In further embodiments, the PVC composition can comprise about 1 to about 3 phr ATO and about 1 to about 3 phr rare earth compound, and in certain of these embodiments the rare earth compound comprises yttrium hydroxide, lanthanum hydroxide, or mixtures thereof. In additional embodiments, the PVC composition can comprise about 1 to less than 3 phr ATO and about 1 to about 3 phr rare earth compound, and in certain of these embodiments the rare earth compound comprises yttrium hydroxide, lanthanum hydroxide, or mixtures thereof. In specific embodiments of any of these embodiments setting forth the phr of ATO and rare earth compound, the amount of rare earth can be approximately equivalent to or more than the amount of ATO. Any of these embodiments setting forth the phr of ATO and rare earth compound may be combined with the above-ratio embodiments as appropriate.

In other embodiments, the PVC compositions contain MDH. In certain of these embodiments, the PVC composition contains about 25 phr to about 50 phr MDH and about 3 phr to about 10 phr rare earth compound. In particular embodiments, the PVC composition contains about 30 phr to about 50 phr MDH. In particular embodiments, the PVC composition contains about 3 phr to about 6 phr rare earth compound. In certain of these embodiments, the rare earth compound comprises yttrium hydroxide, lanthanum hydroxide, or mixtures thereof.

Through the combination of the rare earth compound and MDH, the PVC composition is able to contain less MDH than in an identical PVC composition not containing the rare earth compound and achieve the same UL94 classification (i.e., a UL94 classification with a sample thickness of about 0.8 mm of V-2 or higher/better, and in some embodiments, a UL94 classification with a sample thickness of about 0.8 mm of V-0). In addition, in certain of these embodiments with MDH and rare earth compound, the PVC composition is able to contain about zero phr (i.e., no) ATO and have a desirable UL94 classification (i.e., a UL94 classification with a sample thickness of about 0.8 mm of V-2 or higher/better, and in some embodiments, a UL94 classification with a sample thickness of about 0.8 mm of V-0).

In embodiments with MDH and no ATO, the PVC compositions can contain about 25 phr to about 50 phr MDH and about 3 phr to about 10 phr rare earth compound, or particular embodiments about 30 phr to about 50 phr MDH and/or about 3 phr to about 6 phr rare earth compound. In certain of these embodiments, the rare earth compound comprises yttrium hydroxide, lanthanum hydroxide, or mixtures thereof.

All of the embodiments of the PVC compositions of the present invention have UL94 classification with a sample thickness of about 0.8 mm of V-2 or higher/better. In certain embodiments, these PVC compositions have UL94 classification with a sample thickness of about 0.8 mm of V-0.

In addition to the inorganic flame retardant and rare earth compounds, the PVC compositions can further contain additional additives to impart desirable properties to the PVC. The choice of additives used for the PVC composition is controlled by the performance requirements of the end-use finished product and its specification. For example, underground pipes, siding, intravenous tubing, and flooring have very different performance requirements and thus, require different additives so that the PVC composition is suitable for the end-use product. One of skill in the art understands how to select the additives based on the desired end use. These additives can be fillers, plasticizers, colorants, stabilizers, lubricants, organic flame retardants, smoke suppressants, and mixtures thereof.

It is noted that certain additives can have multiple functions within a PVC composition and one or skill in the art will recognize these multiple functions. As such, the additives with functions as described below are not limiting as to their functions and these additives are categorized by what one of ordinary skill in the art may consider as a primary function of including the particular additive.

The amount of additional additives included in the PVC composition also is controlled by the performance requirements and/or physical characteristics desired for the end-use finished product and its specification(s). The PVC compositions disclosed herein can include amounts of these additional additives such that these additional additives do not alter the decomposition enthalpy of the composition by about 10% or more, and therefore, do not materially affect the flame/fire retardance properties of the PVC compositions as imparted by the inorganic flame retardant in combination with the rare earth compound.

The additives and the amounts of those additives readily can be determined by one of skill in the art.

Fillers are primarily used for cost reduction but also may impart desired properties such as rigidity, flexural modulus, hardness, and density. Fillers that are non-burning further may act, to a limited extent, as flame retardants or smoke suppressants. Fillers that may be included in the PVC compositions as described herein include, for example, calcium carbonates, silicas, silicates, clay, kaolin, magnesium silicates (talc), glass fibers, mica, wollastonite, sodium sulfate (Na₂SO₄), sodium sulfate decahydrate, barium sulfate (BaSO₄), sulfates of the alkaline earth metals, and the like. When present, fillers may be in an amount of about 2 phr to about 400 phr.

Plasticizers can soften PVC compositions, improve processability by reducing viscosity, and improve impact resistance. Some plasticizers that are non-burning further may act, to a limited extent, as flame retardants. Plasticizers that may be included in the PVC compositions as described herein include, for example, ATBC (Acetyl tributyl citrate), DIDP (Diisodecyl phthalate), DINP (Diisononyl phthalate), DOP (dioctyl phthalate or bis(2-ethylhexyl) phthalate), DOTP (dioctyl terephthalate or bis(2-ethylhexyl) terephthalate), and TOTM (Trioctyl trimellitate). Plasticizers generally include phthalates, trimelliates, adipates, adipate diesters, sebacates, benzoates, epoxies, epoxidized soya bean oil, organic phosphates, phosphate esters, polyesters, and the like. Examples of phosphates include, for example, triphenyl phosphate, trixylenyl phosphates, tricresyl phosphate, 2-ethylhexyl diphenyl phosphate (SANTICIZER 141), isodecyl diphenyl phosphate (SANTICIZER 148), octyl diphenyl phosphate (DISFLAMMOL DPO), 2-isopropylphenyl diphenyl phosphate, 3-isopropylphenyl diphenyl phosphate, 4-isopropylphenyl diphenyl phosphate, di(2-isopropylphenyl) phenyl phosphate, and the like. When present, plasticizers may be in an amount of about 15 phr to about 150 phr. Rigid PVC contains no (about 0 phr) plasticizers.

In certain embodiments, the PVC compositions as described herein comprise a plasticizer selected from the group consisting of Dioctyl terephthalate (DOTP), Diisononyl phthalate (DINP), Diisodecyl phthalate (DIDP), and mixtures thereof. In specific of these embodiments, the PVC composition comprises about 35 phr to about 70 phr of the plasticizer. In particular embodiments, the PVC composition comprises about 50 phr Dioctyl terephthalate (DOTP). These specific amounts and types of plasticizers may be included in any of the PVC embodiments as set forth herein.

In particular embodiments of rigid PVC compositions, including any of the embodiments as set forth herein, the PVC compositions comprise about 0 phr of plasticizer.

Colorants can be pigments and/or dyes and are chosen based on color stability, strength, specific gravity, clarity, and electrical properties of the PVC composition and end use product. Pigments are generally insoluble in the PVC composition and can be inorganic or organic compounds. Pigments are dispersed throughout the PVC composition. Pigments are generally chosen based on color stability and compatibility with the PVC composition. Dyes generally are soluble in the PVC composition and also can be inorganic or organic compounds. Pigments that may be included in the PVC compositions as described herein include, for example, inorganic pigments and organic pigments. Inorganic pigments include, for example, titanium dioxide (TiO₂), lead chromate, lead sulfochromate, iron oxide, and Ultramarine blue (a sulfur-containing sodium aluminium silicate). Organic pigments include, for example, carbon black, copper phthalocyanine, diazo condensation products, diazo compounds, polycyclic compounds like dioxazine, quinacridone, isoindolinone, and monoazo compounds like benzimidazolone. When present, colorants may be in an amount of about 1 phr to about 10 phr. When present, pigments may be in an amount of about 1 phr to about 10 phr. When present, dyes may be in an amount of about 1 phr to about 10 phr.

Stabilizers are commonly used PVC additives. Stabilizers help to prevent the initial release of hydrogen chloride, elimination of labile chlorine and carbenium ions, autoxidation, and the addition of polyene sequences all of which contribute to the chain reaction of decomposition. Stabilizers further can increase the PVC composition's resistance to daylight, weathering, and heat ageing, and have an important influence on the physical properties and the cost of a formulation. They can be supplied in the form of application-specific blends of which the main constituents can be metal soaps, metal salts, and organometallic compounds. The choice of heat stabilizer depends on a number of factors, including the technical requirements of the PVC product, regulatory approval requirements, and cost.

Stabilizers that may be included in the PVC compositions as described herein include, for example, antioxidants, antiozonants, light stabilizers, quenchers, acid scavengers, and the like.

Examples of antioxidants include phenolic antioxidants, analogues of phloretic acid, phosphite esters, phosphites, tri(2,4-di-tert-butylphenyl)phosphite, and thioethers.

Examples of antiozonants include p-phenylenediame.

Examples of light stabilizers include hindered amine light stabilizers (HALS), benzotriazoles, benzophenones, organic nickel compounds, and nickel phenolates.

Examples of acid scavengers include metallic soaps, barium stearate, calcium stearate, hydocalumite, calcium oxide, zinc oxide, magnesium oxide, tin, lead, mono and dialkyl tin salts, thio acid half esters such as thio-glycollates often known as thiotins or mercaptides.

Examples of general stabilizers that may impart one or more desired properties are dicarboxylic half esters, often referred to as maleates or carboxylates, mono or dialkyl tin compounds, dibutyltin dichloride (DBTC), dimethyltin dichloride (DMTC), monobutyltin trichloride (MBT), monomethyltin trichloride (MMT), tetra-basic lead sulphate, tri-basic lead sulphate, di-basic lead phosphite, di-basic lead phthalate, di-basic lead stearate, lead stearate, and the like.

When present, stabilizers may be in an amount of about 0.5 phr to about 70 phr. In certain embodiments, stabilizers may be in an amount of about 0.5 phr to about 10 phr.

Lubricants, either external or internal, are added to reduce friction from polymer chain slippage (internal) or between the PVC composition and external surfaces. Lubricants that may be included in the PVC compositions as described herein include, for example, fatty acids, waxes, hydrocarbon wax, polyethylene wax, glycerin dioleate, glycerin monostearate, zinc laurate, glycerin diol, calcium hydroxystearate, EBS ethylene bis(stearamide), hydrogenated castor oil, stearyl stearate, sodium stearyl fumarate, magnesium stearate, zinc stearate, and the like. When present, lubricants may be in an amount of about 0.1 phr to about 1 phr.

Organic flame retardants that may be included in the PVC compositions as described herein include, for example, chlorinated paraffins and brominated organic compounds (like polybrominated diphenyl ethers, polybrominated biphenyl, brominated cyclohydrocarbons), and the like. When present, organic fire retardants may be present in an amount of about 1 phr to about 25 phr.

In certain embodiments the PVC compositions as described herein, including any of the specific embodiments, comprise an organic flame retardant, and in certain of these embodiments, the organic flame retardant is one or more chlorinated paraffins. In these embodiments, the chlorinated paraffins may be present in an amount of about 1 phr to about 25 phr.

However, these halogenated organic flame retardant additives, and in particular chlorinated paraffins, are not considered “environmentally friendly”. In some jurisdictions, such as within Europe, these chlorinated paraffins are banned from use. Thus, in certain embodiments of the PVC compositions as disclosed herein, including any of the specific embodiments, the compositions comprise about 0 phr (i.e., no) chlorinated paraffins. It is an advantage of the present PVC compositions that these PVC compositions can achieve the UL94 classification and not require these chlorinated paraffins.

Smoke suppressants that may be included in the PVC compositions as described herein include, for example, ammonium octamolybdate, molybdenum trioxide, zinc borate (2ZnO 3B₂O₃⋅3.5H₂O, or ZnO B₂O₃⋅2H₂O, or 2ZnO 2B₂O₃⋅3H₂O), barium borate, copper oxalate, zinc stannates (ZnSnO₃), zinc hydroxystannate (ZnSn(OH)6), zinc sulfide, and the like. Zinc hydroxy stannate also can have some flame retardant properties. When present, smoke suppressants may be present in an amount of about 1 phr to about 20 phr.

Further optional additives may include one or more of the following:

Blowing agents or foaming agents, which are used to create a cellular structure or a foam by decomposing under heat to release a gas. These blowing or foaming agents include, for example, carbonates, ammonium carbonate, sodium carbonate, azo compounds, azodicarbonamide (azo-bisformamide) in amounts of about 0.3 phr to about 1 phr;

Microspheres;

Water repellents;

Impact modifiers, which function to increase toughness, such as chlorinated polyethylene and acrylic copolymers such as MBS (methylacrylate butadiene styrene); MABS (methacrylateacrylonitrile-butadiene-styrene copolymers), (NPDEs) non-predefined elastomers;

Matting agents, such as methyl methacrylate;

Process oils/base, such as paraffin oil in an amount of about 1 phr to about 2 phr;

Processing aids; and

Solvents and intermediates, such as methyl ethyl ketone, methyl isobutyl ketone, and white spirit;

One of skill in the art understands how to select the appropriate additives and amount (in phr) of these additives to include to provide a PVC composition meeting the performance requirements and/or physical characteristics desired for the end-use finished product and its specification(s). This end-use PVC product also may be dyed to meet desired physical characteristics.

These additional additives must be PVC formulating friendly and exhibit good compatibility with the other PVC composition components. Tensile strength and mechanical properties such as processability of the PVC product may be important crucial.

The rare earth compounds used in the PVC compositions as described herein have several advantageous attributes as a PVC additive including 1) a significant endothermic decomposition which releases water and forms a refractory oxide layer, 2) halogen-free, 3) non-toxic and stable, 4) Non-volatile and chemical neutrality, 5) aesthetically colorless, 6) ready availability and economically viable, 7) readily processable into small particle sizes, 8) low solubility and leachability, 9) acid scavenger ability to trap the HCl, 10) thermal stabilization, and 11) smoke suppressant.

As described above, the disclosed PVC compositions have a UL94 classification with a sample thickness of about 0.8 mm of V-2 or higher/better. In certain embodiments, these PVC compositions as disclosed herein have a UL94 classification with a sample thickness of about 0.8 mm of V-2, V-1, or V-0. In particular embodiments, these PVC compositions as disclosed herein have a UL94 classification with a sample thickness of about 0.8 mm of V-0.

The disclosed PVC compositions also can exhibit desirable thermal stability as measured by CongoRed at 200° C. The CongoRed test method determines the thermal stability of a PVC composition when processed at a high temperature. The method is applicable to all PVC compositions, copolymers and products based on them. The CongoRed test is performed at a temperature of 200° C. according to the procedure as outlined in International Standard ISO 182-1. The time (in minutes) taken for the material to degrade, indicated by evolution of hydrogen chloride, is determined by a change of color in a CongoRed test paper. In certain embodiments, the PVC compositions as disclosed herein, including any of the above specified embodiments, have a CongoRed at 200° C. of about 90 mins to about 200 mins.

In certain embodiments, the PVC compositions containing the rare earth compounds contain reduced amounts of these inorganic flame retardants (and in particular ATO) while achieving the same CongoRed at 200° C. as an identical PVC composition not containing the rare earth compounds. In further embodiments, the PVC compositions containing the rare earth compounds contain reduced amounts of these inorganic flame retardants (and in particular ATO) while achieving an improved CongoRed at 200° C. as an identical PVC composition not containing the rare earth compounds.

The disclosed PVC compositions also can exhibit desirable limiting oxygen index (LOI) indicating the flammability of the PVC composition in terms of the minimum concentration of oxygen that is required to allow the PVC composition to sustain. The limiting oxygen index (LOI) of the PVC compositions as disclosed herein is determined according to ASTM D2863. In certain embodiments, the PVC compositions as disclosed herein, including any of the above specified embodiments, have a LOI of about 20 to about 35.

Without being bound by the theory, the PVC compositions as disclosed herein comprising an inorganic flame retardant in combination with a rare earth compound may be able to absorb heat produced during combustion by undergoing an endothermic release upon heating, particularly throughout the range of temperatures relevant to combustion of the PVC composition/product. For instance, the rare earth compounds as disclosed herein release water upon heating. This endothermic release absorbs heat energy from the surrounding material to slow combustion, and the release of the water further dampens combustion by limited access to oxygen and cooling the surrounding material. In some embodiments, the PVC compositions disclosed herein can interrupt an otherwise self-sustaining combustion cycle of the PVC. As noted above, this can be an endothermic process, and therefore, reduce the heat below the threshold needed to sustain combustion of the PVC. In addition to absorbing heat through the endothermic release, the water released during oxidation can further cool and dilute the oxygen necessary to the combustion process.

The rare earth compounds disclosed herein also can behave as Lewis acid catalysts resulting in an acid scavenging function, by producing a chlorinated Lewis acid catalyst. This action may absorb acidic gases emitted during combustion of the PVC composition, such as HCl. Upon combustion, the rare earth compounds can form an insulating carbonaceous char layer via crosslinking, and due to strong acid scavenger characteristics, also can sequester HCl gas from smoke within the char layer, thereby decreasing smoke acidity. As such, the rare earth compounds may be able to seal the PVC and inhibit the release of gasses from the combustible components that would otherwise contribute to continuing pyrolysis. In this manner, the combustible portion of the PVC can be effectively sequestered from the ignition source upon oxidation of the rare earth compound by heating. In certain embodiments, the strong oxophilicity of the lanthanum rare earth compounds may contribute to reduction of chloride during combustion, by formation of chloride intermediates that are stable up to 1000° C. Thus, the rare earth compounds are unexpectedly advantageous additives/components of the PVC compositions as disclosed herein. As such, the rare earth compounds allow for reduced amounts of the inorganic flame retardants (an in particular ATO) and achieve the same UL94 classification (i.e., a UL94 classification with a sample thickness of about 0.8 mm of V-2 or higher/better, and in some embodiments, a UL94 classification with a sample thickness of about 0.8 mm of V-0) as an identical PVC composition not containing the rare earth compounds.

In one particular embodiment of the PVC composition, it comprises PVC resin; ATO; and a rare earth hydroxide comprising Y(OH)3, La(OH)3, or a mixture thereof. This PVC composition comprises 100 phr of PVC resin and comprises ATO and rare earth hydroxide collectively in an amount of about 3 phr to about 10 phr. This PVC composition has a UL94 classification with a sample thickness of about 0.8 mm of V-0, V-1, or V-2 and contains less ATO than in an identical PVC composition not containing the rare earth hydroxide to achieve the same UL94 classification. In certain embodiments, this PVC composition has a UL94 classification with a sample thickness of about 0.8 mm of V-0. Additionally, this PVC composition also may have a CongoRed at 200° C. of about 90 mins to about 200 mins.

This embodiment can include any of the ATO to rare earth compound ratios as described herein. Additionally, in certain of these embodiments, the PVC composition can comprise about 1 to about 3.5 phr ATO and about 1 to about 3.5 phr rare earth compound, and in further of these embodiments, the PVC composition can comprise about 1 to about 3 phr ATO and about 1 to about 3 phr rare earth compound. In additional of these embodiments, the PVC composition can comprise about 1 to less than 3 phr ATO and about 1 to about 3 phr rare earth compound.

These particular embodiments can further comprise one or more of the additives as described herein. As such, these particular PVC compositions can further comprise an additive selected from the group consisting of fillers, plasticizers, colorants, stabilizers, lubricants, organic flame retardants, smoke suppressants, and mixtures thereof. These additives are as described above.

In certain embodiments of this particular PVC composition, it contains about 0 phr (i.e., no) chlorinated paraffins.

In another particular embodiment of the PVC composition, it comprises 100 phr PVC resin; about 25 phr to about 50 phr MDH; and about 3 phr to about 10 phr rare earth hydroxide, wherein the rare earth hydroxide comprises Y(OH)₃, La(OH)₃, or a mixture thereof. This PVC composition has a UL94 classification with a sample thickness of about 0.8 mm of V-0, V-1, or V-2. In certain embodiments, this PVC composition has a UL94 classification with a sample thickness of about 0.8 mm of V-0. Additionally, this PVC composition also may have a CongoRed at 200° C. of about 90 mins to about 200 mins.

Through the combination of the rare earth compound and MDH, the PVC composition is able to contain less MDH than in an identical PVC composition not containing the rare earth compound and achieve the same UL94 classification (i.e., a UL94 classification with a sample thickness of about 0.8 mm of V-2 or higher/better, and in some embodiments, a UL94 classification with a sample thickness of about 0.8 mm of V-0). In addition, in certain of these embodiments with MDH and rare earth compound, the PVC composition is able to contain about zero phr (i.e., no) ATO and have a desirable UL94 classification (i.e., a UL94 classification with a sample thickness of about 0.8 mm of V-2 or higher/better, and in some embodiments, a UL94 classification with a sample thickness of about 0.8 mm of V-0).

In specific embodiments with MDH and about zero phr (i.e., no) ATO, the PVC compositions can contain about 25 phr to about 50 phr MDH and about 3 phr to about 6 phr rare earth compound.

In other specific embodiments with MDH and about zero phr (i.e., no) ATO, the PVC compositions can contain about 30 phr to about 50 phr MDH and about 3 phr to about 6 phr rare earth compound.

These particular embodiments can further comprise one or more of the additives as described herein. As such, these particular PVC compositions can further comprise an additive selected from the group consisting of fillers, plasticizers, colorants, stabilizers, lubricants, organic flame retardants, smoke suppressants, and mixtures thereof. These additives are as described above.

Any of the embodiments of the PVC compositions as disclosed herein can be used for a variety of end-use products, well known to those of skill in the art. These type of products include, for example, window frames, doors and door framing, drainage pipe, water service pipe, plumbing pipes, roofing, siding, trim for housing and automotive uses, and flooring. Additional products include plastic bottles, packaging, cling film, and credit, bank or membership cards. Further products include electrical cable insulation or housing, medical devices, blood storage bags, cable and wire insulation, fashion and footwear, inflatable products, and vinyl records. PVC compositions can be included in coated fabrics for protective coating. PVC products further include shower curtains and signage. PVC products additional include sporting goods products such as tents, kayaks, climbing gear and the like.

As described herein, one of skill in the art understands how to select the additional additives and the amount of those additives to include to provide a PVC composition meeting the performance requirements and/or physical characteristics desired for these end-use finished products and their respective specification(s).

### Preparation of PVC Compositions

Processes for preparing the PVC compositions are well known in the art and the PVC compositions as disclosed herein can be prepared by any of these known processes. These processes are not limited by any particular steps or methods, and generally can be any that result in a mixture of PVC resin, inorganic flame retardant, and rare earth compound in a suitable PVC composition. The rare earth compound and inorganic flame retardant may be blended together initially, and with any other additives, and then added to a PVC resin. Or the PVC resin, rare earth compound, and inorganic flame retardant, and optional additional additives, may all be blended together at the outset and then processed to provide the PVC composition. The resulting mixture can be either homogenous or heterogeneous. Processes to provide the PVC composition typically further include milling and heating. The process optionally may further include downstream processing steps (e.g., drying steps). These processes to prepare the PVC compositions and then the end-use products can include any processing steps commonly utilized to prepare PVC compositions and end use products as long as the desired physical characteristics of the PVC composition and end use PVC are provided and retained.

The PVC compositions can be prepared by compounding equipment, for example injection molding or extrusion techniques, to provide PVC compositions with excellent dispersibility and thermo-mechanical properties.

### EXAMPLES

Thermogravimetric analysis (TGA) data and differential scanning calorimetry (DSC) data for examples disclosed herein were obtained using a TA Instruments® Q600 SDT under simultaneous TGA-DSC operation. Each sample was heated at a rate of 10° C./min from room temperature to 1000° C. using air as the active gas at a rate of 90 mL/min and an N₂ balance gas at a flow rate of 10 mL/min. In some instances, TGA and DSC data for each sample was normalized to reflect the weight of the sample at 200° C. to account for weight loss from the sample expected to occur during the PVC fabrication process. DSC data was also normalized to reflect the decomposition enthalpy of each sample relative to a starting point of 200° C. Loss on Ignition was measured by heating a weighed sample in a furnace at 1000° C. for 1 hour and weighing the remaining solid. The particle size was measured using a Malvern Mastersizer 2000. X-ray Diffraction was performed using a Bruker D2 Phaser X-Ray Diffactometer. The peak width at half height was used to determine the crystallite size. The Dₓₓ sizes are the size of the particles that are made-up of the individual crystallites and is measured by laser diffraction.

The density of PVC samples was measured by observing the volume change when a previously weighed sample was submersed in water. Hardness Shore A measurements were carried out according to ASTM D2240.

The limiting oxygen index (LOI) of each compounded material was determined to assess the fire retardance of each sample according to ASTM D2863. LOI determines the flammability of materials in terms of the minimum concentration of oxygen that is required to allow materials to sustain a candle-like burning behavior. Oxygen concentration is expressed as a percentage by volume of oxygen in a flowing mixture of oxygen and nitrogen. Bar-shaped specimens with size 12.5 mm×100 mm and 3 mm thickness were used in accordance with ISO4589 standard. The sample was ignited at the top and burning time of the ignited specimen is recorded at different oxygen concentrations in order to determine the minimum oxygen concentration to sustain burning for at least three minutes after removal of ignition flame. A Fire Testing Technology (FTT) model apparatus equipped with an oxygen analyzer was used for this test. Tests were repeated up to five times per formulation until LOI was determined to an acceptable confidence.

The CongoRed test was performed according to the procedure outlined in International Standard ISO 182-1 at a temperature of 200° C.

Smoke Density testing was carried out according to ASTM D2843. Color stability was tested by placing samples in an oven at 190° C. for 1 hour. Afterwards the color is visually compared to the unheated sample.

UL94, the Standard for Safety of Flammability of Plastic Materials for Parts in Devices and Appliances testing was carried out according to Standard 94, Edition 7. A summary of the UL94 ratings is in Table 1 above, where the rating increases in the order of not classifiable (NC), HB, V-2, V-1, V-0, 5VB, and 5VA.

Materials used in the following examples include the following. PVC resin k70 which is a high molecular weight vinyl chloride homopolymer produced by a suspension process and is listed under CAS number 9002-86-2. The plasticizers used in the following examples include dioctyl terephthalate (DOTP) (CAS number 6422-86-2), diisononyl phthalate (DINP) (CAS number 28553-12-0 or 68515-48-0), and diisodecyl phthalate (DIDP) (CAS number 26761-40-0) but others can be used. The chlorinated paraffins used are considered both flame retardants and plasticizers and are CP52 chlorinated paraffin 52% Cl (CAS number 85535-85-9) and Essebiochlor 45 which is a mixture of chlorinated vegetable fatty acid esters and thus a chlorinated paraffin. Chlorinated paraffins come in a variety of carbon chain lengths and a variety of chlorination levels. They fall under two CAS numbers 85535-85-9 and 63449-39-8. Inorganic flame retardants used include magnesium dihydroxide (MDH) (CAS number 1309-42-8) and antimony trioxide (ATO) (CAS number 1309-64-4). Two different MDHs were used although any MDH could have been used. The two MDH used are Ecopiren 3.5C which is produced from ground brucite (a naturally occurring mineral) and Ecopiren 5.5C which is a MDH coated with stearic acid (CAS number 57-11-4). Two inorganic filler/acid scavengers were used. Omyacarb 2T-AV (CAS number 1317-65-3) is a ground calcium carbonate (CaCO₃). Winnofil® S is an ultrafine CaCO₃. The smoke suppressant used was zinc borate (CAS 1332-07-6). A calcium zinc stabilizer from Reagens was also used. Calcium zinc stabilizers for PVC are generally a mixture of calcium and zinc carboxylates but may include polyols, epoxydized soya bean oil, antioxidants and organic phosphites.

### Example 1

### Synthesis of Yttrium Hydroxide

Yttrium hydroxide was prepared by first preparing a Y(NO₃)₃ solution, containing 250 mg yttrium oxide basis/L. The Y(NO₃)₃ solution was then added to a solution of approximately 10 M NaOH or 5.5 M NH₄OH at a ratio of at least about 6 moles of OH to 1 mole of metal. The precipitate was collected by filtration and washed with DI water until conductivity of the aqueous was less than 30 mS/cm. Filtration continued to dewater the resulting cake. The precipitated hydroxide was then dried at 80° C. to 200° C. for 6 hours. The material was then jet-milled.

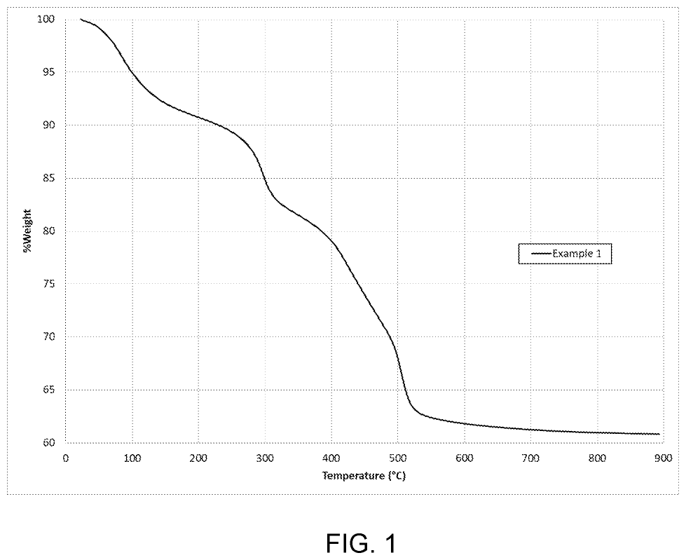

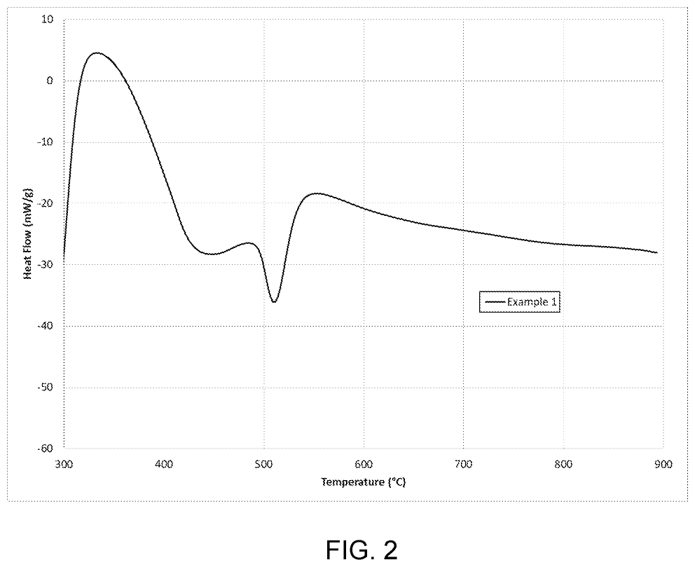

The resulting solid was analyzed via TGA/DSC. Mass loss corresponding to release of water was observed at 250, 390, and 460° C. as shown in FIG. 1. The DSC reveals endothermic transitions at approximately 450 and 510° C. corresponding to enthalpies of approximately 270 and 155 J/g respectively as show in FIG. 2. The particle size was measured and found to have a D50 of approximately 2.2 μm, a D90 of approximately 4.2 μm, and a D100 of approximately 7.3 μm. The loss on ignition was found to be 39.37% which indicates the % Y₂O₃ is 60.63%. The solid was also analyzed by x-ray diffraction and found to have a crystallite size of 15.99 nm.

### Example 2

The following examples compare PVC formulations with a minimal about of additives. The four formulations of example 2 are a PVC with neither ATO nor the yttrium hydroxide of example 1, a PVC with ATO, a PVC with the yttrium hydroxide of example 1, and a PVC with both ATO and the yttrium hydroxide of example 1. These examples show that ATO is needed to achieve the UL94 rating required herein and the addition of yttrium hydroxide increases thermal stability and allows for reducing the amount of ATO.

### Comparative Example 2A

### Polyvinyl Chloride Preparation

A two roll mill machine was loaded with Polyvinyl chloride resin (PVC resin k70), a plasticizer (dioctyl terephthalate (DOTP)), and a stabilizer (Stab Ca/Zn CBS 209/7, calcium zinc stearate). The amounts of each component can be adjusted for the desired properties of the resulting PVC. In this example the polyvinyl chloride content was 1 kg (100 phr), the plasticizer was 0.5 kg (50 phr), and the stabilizer was 0.05 kg (5 phr) for a total of 1.55 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.24 g/cm³. Hardness of the material was measured at 91. The Limiting Oxygen Index (LOI) was measured to be 23%. The CongoRed test resulted in 122 min. The UL94 classification was not classifiable.

### Comparative Example 2B

### Polyvinyl Chloride Preparation with Antimony Trioxide (ATO)

A two roll mill machine was loaded with Polyvinyl chloride resin (PVC resin k70), a plasticizer (dioctyl terephthalate (DOTP)), a stabilizer (Stab Ca/Zn CBS 209/7, calcium zinc stearate), and a flame retardant (antimony trioxide). The amounts of each component can be adjusted for the desired properties of the resulting PVC. In this example the polyvinyl chloride content was 1 kg (100 phr), the plasticizer was 0.5 kg (50 phr), the stabilizer was 0.05 kg (5 phr), and the flame retardant 0.05 kg (5 phr) for a total of 1.60 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.25 g/cm³. Hardness of the material was measured at 91. The Limiting Oxygen Index (LOI) was measured to be 28%. The CongoRed test resulted in 124 min. The UL94 classification was determined to be V-0.

### Example 2A

### Polyvinyl Chloride Preparation with Yttrium Hydroxide of Example 1

A two roll mill machine was loaded with Polyvinyl chloride resin (PVC resin k70), a plasticizer (dioctyl terephthalate (DOTP)), a stabilizer (Stab Ca/Zn CBS 209/7, calcium zinc stearate), and yttrium hydroxide of example 1. The amounts of each component can be adjusted for the desired properties of the resulting PVC. In this example the polyvinyl chloride content was 1 kg (100 phr), the plasticizer was 0.5 kg (50 phr), the stabilizer was 0.05 kg (5 phr), and the yttrium hydroxide of example 1 0.05 kg (5 phr) for a total of 1.60 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.26 g/cm³. Hardness of the material was measured at 89. The Limiting Oxygen Index (LOI) was measured to be 22%. The CongoRed test resulted in 177 min. The UL94 classification was determined to be not classifiable.

### Example 2B

### Polyvinyl Chloride Preparation with Antimony Trioxide and Yttrium Hydroxide of Example 1

A two roll mill machine was loaded with Polyvinyl chloride resin (PVC resin k70), a plasticizer (dioctyl terephthalate (DOTP)), a stabilizer (Stab Ca/Zn CBS 209/7, calcium zinc stearate), a flame retardant (antimony trioxide), and yttrium hydroxide of example 1. The amounts of each component can be adjusted for the desired properties of the resulting PVC. In this example the polyvinyl chloride content was 1 kg (100 phr), the plasticizer was 0.5 kg (50 phr), the stabilizer was 0.05 kg (5 phr), the flame retardant 0.025 kg (2.5 phr), and the yttrium hydroxide of example 1 0.025 kg (2.5 phr) for a total of 1.60 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.28 g/cm³. Hardness of the material was measured at 88. The Limiting Oxygen Index (LOI) was measured to be 27%. The CongoRed test resulted in 175 min. The UL94 classification was determined to be V-0.

TABLE 2
Components and measurements from Example 2

| | Comparative | Comparative | | |
|---|---|---|---|---|
| | Example 2A | Example 2B | Example 2A | Example 2B |
| PVC resin k70 (phr) | 100 | 100 | 100 | 100 |
| DOTP (phr) | 50 | 50 | 50 | 50 |
| ATO (phr) | — | 5 | — | 2.5 |
| Yttrium hydroxide (phr) | — | — | 5 | 2.5 |
| Stab Ca/Zn CBS 209/7 (phr) | 5 | 5 | 5 | 5 |
| Total (phr) | 155 | 160 | 160 | 160 |
| Density | 1.24 | 1.25 | 1.26 | 1.28 |
| Hardness Shore A | 91 | 91 | 89 | 88 |
| Limiting Oxygen Index | 23 | 28 | 22 | 27 |
| CongoRed@200° C. (min) | 122 | 124 | 177 | 175 |
| UL94 classification | Not classifiable | V-0 | Not classifiable | V-0 |

### Example 3

The following examples of PVC formulations show that a smoke suppressant such as zinc borate can be added, and similar results are observed. As the quantity of yttrium hydroxide increases, the quantity of ATO can be reduced and the thermal stability increases.

### Comparative Example 3A

### Polyvinyl Chloride Preparation

A two roll mill machine was loaded with Polyvinyl chloride resin (PVC resin k70), a plasticizer (dioctyl terephthalate (DOTP)), a stabilizer (CaCO₃ omyacarb 2T-AV), a smoke suppressant (zinc borate), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.5 kg (50 phr), the CaCO₃ stabilizer was 0.8 kg (80 phr), the smoke suppressant was 0.02 kg (2 phr) and the calcium zinc stearate stabilizer was 0.03 kg (3 phr) for a total of 2.35 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.512 g/cm³. Hardness of the material was measured at 88. The Limiting Oxygen Index (LOI) was measured to be 25%. The CongoRed test resulted in 93 min. The UL94 classification was not classifiable. The color stability showed no change in color.

### Comparative Example 3B

### Polyvinyl Chloride Preparation with ATO

A two roll mill machine was loaded with Polyvinyl chloride resin (PVC resin k70), a plasticizer (dioctyl terephthalate (DOTP)), a stabilizer (CaCO₃ omyacarb 2T-AV), a flame retardant (antimony trioxide), a smoke suppressant (zinc borate), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.5 kg (50 phr), the CaCO₃ stabilizer was 0.8 kg (80 phr), the flame retardant was 0.04 kg (4 phr), the smoke suppressant was 0.02 kg (2 phr) and the calcium zinc stearate stabilizer was 0.03 kg (3 phr) for a total of 2.39 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.531 g/cm³. Hardness of the material was measured at 89. The Limiting Oxygen Index (LOI) was measured to be 30%. The CongoRed test resulted in 104 min. The UL94 classification was determined to be V-0. The color stability showed no change in color.

### Example 3A

### Polyvinyl Chloride Preparation with ATO and Yttrium Hydroxide of Example 1

A two roll mill machine was loaded with Polyvinyl chloride resin (PVC resin k70), a plasticizer (dioctyl terephthalate (DOTP)), a stabilizer (CaCO₃ omyacarb 2T-AV), a flame retardant (antimony trioxide), the yttrium hydroxide of example 1, a smoke suppressant (zinc borate), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.5 kg (50 phr), the CaCO₃ stabilizer was 0.8 kg (80 phr), the flame retardant was 0.03 kg (3 phr), the yttrium hydroxide of example 1 was 0.01 kg (1 phr), the smoke suppressant was 0.02 kg (2 phr) and the calcium zinc stearate stabilizer was 0.03 kg (3 phr) for a total of 2.39 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.534 g/cm³. Hardness of the material was measured at 90. The Limiting Oxygen Index (LOI) was measured to be 29%. The CongoRed test resulted in 128 min. The UL94 classification was determined to be V-0. The color stability showed a slight darkening.

### Example 3B

### Polyvinyl Chloride Preparation with ATO and Yttrium Hydroxide of Example 1

A two roll mill machine was loaded with Polyvinyl chloride resin (PVC resin k70), a plasticizer (dioctyl terephthalate (DOTP)), a stabilizer (CaCO₃ omyacarb 2T-AV), a flame retardant (antimony trioxide), the yttrium hydroxide of example 1, a smoke suppressant (zinc borate), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.5 kg (50 phr), the CaCO₃ stabilizer was 0.8 kg (80 phr), the flame retardant was 0.02 kg (2 phr), the yttrium hydroxide of example 1 was 0.02 kg (2 phr), the smoke suppressant was 0.02 kg (2 phr) and the calcium zinc stearate stabilizer was 0.03 kg (3 phr) for a total of 2.39 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.529 g/cm³. Hardness of the material was measured at 89. The Limiting Oxygen Index (LOI) was measured to be 27%. The CongoRed test resulted in 156 min. The UL94 classification was determined to be V-0. The color stability showed a darkening and was slightly darker than in Example 3A.

### Example 3C

### Polyvinyl Chloride Preparation with ATO and Yttrium Hydroxide of Example 1

A two roll mill machine was loaded with Polyvinyl chloride resin (PVC resin k70), a plasticizer (dioctyl terephthalate (DOTP)), a stabilizer (CaCO₃ omyacarb 2T-AV), a flame retardant (antimony trioxide), the yttrium hydroxide of example 1, a smoke suppressant (zinc borate), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.5 kg (50 phr), the CaCO₃ stabilizer was 0.8 kg (80 phr), the flame retardant was 0.01 kg (1 phr), the yttrium hydroxide of example 1 was 0.03 kg (3 phr), the smoke suppressant was 0.02 kg (2 phr) and the calcium zinc stearate stabilizer was 0.03 kg (3 phr) for a total of 2.39 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.529 g/cm³. Hardness of the material was measured at 89. The Limiting Oxygen Index (LOI) was measured to be 26%. The CongoRed test resulted in 156 min. The UL94 classification was determined to be V-2. The color stability showed a darkening and was slightly darker than in Example 3B.

TABLE 3
Components and measurements from Example 3

| | Comparative | Comparative | | | |
|---|---|---|---|---|---|
| | Example 3A | Example 3B | Example 3A | Example 3B | Example 3C |
| PVC resin k70 (phr) | 100 | 100 | 100 | 100 | 100 |
| DOTP (phr) | 50 | 50 | 50 | 50 | 50 |
| CaCO₃ omyacarb 2T-AV | 80 | 80 | 80 | 80 | 80 |
| (phr) | | | | | |
| ATO (phr) | — | 4 | 3 | 2 | 1 |
| Yttrium hydroxide (phr) | — | — | 1 | 2 | 3 |
| Zinc borate | 2 | 2 | 2 | 2 | 2 |
| Stab Ca/Zn CBS 209/7 | 3 | 3 | 3 | 3 | 3 |
| (phr) | | | | | |
| Total (phr) | 235 | 239 | 239 | 239 | 239 |
| Density | 1.512 | 1.531 | 1.534 | 1.529 | 1.529 |
| Hardness Shore A | 88 | 89 | 90 | 89 | 89 |
| Limiting Oxygen Index | 25 | 30 | 29 | 27 | 26 |
| CongoRed@200° C. (min) | 93 | 104 | 128 | 156 | 156 |
| UL94 classification | Not classifiable | V-0 | V-0 | V-0 | V-2 |

### Example 4

The following examples relate to PVC formulations that include magnesium dihydroxide (MDH) as a flame retardant additive. The three examples compare a sample with ATO, a sample where two thirds of the ATO has been replaced with a smoke suppressant zinc borate, and a sample where two thirds of the ATO has been replaced with the yttrium hydroxide of example 1. The results show the addition of yttrium hydroxide increases thermal stability, provides similar smoke suppression as zinc borate, and the PVC does not darken as much when heated.

### Comparative Example 4A

### Polyvinyl Chloride Preparation with MDH and ATO

A two roll mill machine was loaded with Polyvinyl chloride resin (PVC resin k70), a plasticizer (diisodecyl phthalate (DIDP)), an inorganic flame retardant (Ecopiren 3.5C a magnesium dihydroxide (MDH)), a stabilizer (CaCO₃ omyacarb 2T-AV), an inorganic flame retardant (antimony trioxide (ATO)), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.5 kg (50 phr), the inorganic flame retardant MDH was 0.3 kg (30 phr), the CaCO₃ stabilizer was 0.5 kg (50 phr), the inorganic flame retardant ATO was 0.06 kg (6 phr), and the calcium zinc stearate stabilizer was 0.03 kg (3 phr) for a total of 2.39 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.532 g/cm³. Hardness of the material was measured at 88. The Limiting Oxygen Index (LOI) was measured to be 29%. The CongoRed test resulted in 60 min. The UL94 classification was determined to be V-0. The color stability showed some darkening. The smoke density rating was determined to be 72%.

### Comparative Example 4B

### Polyvinyl Chloride Preparation with MDH, ATO, and Zinc Borate

A two roll mill machine was loaded with Polyvinyl chloride resin (PVC resin k70), a plasticizer (diisodecyl phthalate (DIDP)), an inorganic flame retardant (Ecopiren 3.5C a magnesium dihydroxide (MDH)), a stabilizer (CaCO₃ omyacarb 2T-AV), an inorganic flame retardant (antimony trioxide (ATO)), a smoke suppressant (zinc borate), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.5 kg (50 phr), the inorganic flame retardant MDH was 0.3 kg (30 phr), the CaCO₃ stabilizer was 0.5 kg (50 phr), the inorganic flame retardant ATO was 0.02 kg (2 phr), the smoke suppressant zinc borate was 0.04 kg (4 phr), and the calcium zinc stearate stabilizer was 0.03 kg (3 phr) for a total of 2.39 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.518 g/cm³. Hardness of the material was measured at 85. The Limiting Oxygen Index (LOI) was measured to be 28%. The CongoRed test resulted in 53 min. The UL94 classification was determined to be V-0. The color stability showed significant darkening and some blackening due to the presence of zinc. The smoke density rating was determined to be 59%.

### Example 4A

### Polyvinyl Chloride Preparation with MDH, ATO, and Yttrium Hydroxide of Example 1

A two roll mill machine was loaded with Polyvinyl chloride resin (PVC resin k70), a plasticizer (diisodecyl phthalate (DIDP)), an inorganic flame retardant (Ecopiren 3.5C a magnesium dihydroxide (MDH)), a stabilizer (CaCO₃ omyacarb 2T-AV), an inorganic flame retardant (antimony trioxide (ATO)), the yttrium hydroxide of example 1, and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.5 kg (50 phr), the inorganic flame retardant MDH was 0.3 kg (30 phr), the CaCO₃ stabilizer was 0.5 kg (50 phr), the inorganic flame retardant ATO was 0.02 kg (2 phr), the yttrium hydroxide of example 1 was 0.04 kg (4 phr), and the calcium zinc stearate stabilizer was 0.03 kg (3 phr) for a total of 2.39 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.519 g/cm³. Hardness of the material was measured at 89. The Limiting Oxygen Index (LOI) was measured to be 27%. The CongoRed test resulted in 92 min. The UL94 classification was determined to be V-0. The color stability showed less darkening than comparative examples 4A and 4B. The smoke density rating was determined to be 59%.

TABLE 4
Components and measurements from Example 4

| | Comparative | Comparative | |
|---|---|---|---|
| | Example 4A | Example 4B | Example 4A |
| PVC resin k70 (phr) | 100 | 100 | 100 |
| DIDP (phr) | 50 | 50 | 50 |
| Ecopiren 3.5C (MDH) | 30 | 30 | 30 |
| (phr) | | | |
| CaCO₃ omyacarb 2T-AV | 50 | 50 | 50 |
| (phr) | | | |
| ATO (phr) | 6 | 2 | 2 |
| Yttrium hydroxide of | — | — | 4 |
| Example 1 (phr) | | | |
| Zinc Borate (phr) | — | 4 | — |
| Stab Ca/Zn CBS 209/7 | 3 | 3 | 3 |
| (phr) | | | |
| Total (phr) | 239 | 239 | 239 |
| Density | 1.532 | 1.518 | 1.519 |
| Hardness Shore A | 88 | 85 | 89 |
| Limiting Oxygen Index | 29 | 28 | 27 |
| CongoRed@200° C. (min) | 60 | 53 | 92 |
| UL94 classification | V-0 | V-0 | V-0 |
| Smoke density rating (%) | 72 | 59 | 59 |

### Example 5

The following two examples compare a PVC formulation with chlorinated paraffin, ATO, and zinc borate to a similar PVC formulation with the yttrium hydroxide of example 1 replacing a portion of the ATO. The results show an increase in thermal stability and a reduction in the amount of ATO when utilizing the yttrium hydroxide.

Comparative Example 5. Polyvinyl chloride preparation with chlorinated paraffin and ATO

A two roll mill machine was loaded with Polyvinyl chloride resin (PVC resin k70), a plasticizer (diisodecyl phthalate (DIDP)), a chlorinated paraffin (Essebiochlor 45), a stabilizer (CaCO₃ omyacarb 2T-AV), an inorganic flame retardant (antimony trioxide (ATO)), a smoke suppressant (zinc borate), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.35 kg (35 phr), the chlorinated paraffin was 0.15 kg (15 phr), the inorganic flame retardant ATO was 0.06 kg (6 phr), the CaCO₃ stabilizer was 0.8 kg (80 phr), the smoke suppressant was 0.02 kg (2 phr) and the calcium zinc stearate stabilizer was 0.03 kg (3 phr) for a total of 2.41 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.568 g/cm³. Hardness of the material was measured at 88. The Limiting Oxygen Index (LOI) was measured to be 29%. The CongoRed test resulted in 35 min. The UL94 classification was determined to be V-0. The Color stability showed some darkening.

### Example 5

### Polyvinyl Chloride Preparation with Chlorinated Paraffin, ATO, and the Yttrium Hydroxide of Example 1

A two roll mill machine was loaded with Polyvinyl chloride resin (PVC resin k70), a plasticizer (diisodecyl phthalate (DIDP)), a chlorinated paraffin (Essebiochlor 45), a stabilizer (CaCO₃ omyacarb 2T-AV), an inorganic flame retardant (antimony trioxide (ATO)), the yttrium hydroxide of example 1, a smoke suppressant (zinc borate), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.35 kg (35 phr), the chlorinated paraffin was 0.15 kg (15 phr), the inorganic flame retardant ATO was 0.03 kg (3 phr), the CaCO₃ stabilizer was 0.8 kg (80 phr), the yttrium hydroxide of example 1 was 0.03 (3 phr), the smoke suppressant was 0.02 kg (2 phr) and the calcium zinc stearate stabilizer was 0.03 kg (3 phr) for a total of 2.41 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.561 g/cm³. Hardness of the material was measured at 89. The Limiting Oxygen Index (LOI) was measured to be 27%. The CongoRed test resulted in 47 min. The UL94 classification was determined to be V-0. The Color stability showed some darkening.

TABLE 5
Components and measurements from Example 5

| | Comparative | |
|---|---|---|
| | Example 5 | Example 5 |
| PVC resin k70(phr) | 100 | 100 |
| DIDP (phr) | 35 | 35 |
| Essebiochlor 45 (phr) | 15 | 15 |
| ATO (phr) | 6 | 3 |
| Yttrium hydroxide (phr) | — | 3 |
| CaCO₃ omyacarb 2T-AV | 80 | 80 |
| Zinc Borate (phr) | 2 | 2 |
| Stab Ca/Zn CBS 209/7 (phr) | 3 | 3 |
| Total (phr) | 241 | 241 |
| Density | 1.568 | 1.561 |
| Hardness Shore A | 88 | 89 |
| Limiting Oxygen Index | 29 | 27 |
| CongoRed@200° C. (min) | 35 | 47 |
| UL94 classification | V-0 | V-0 |

### Example 6

The following examples compare PVC formulations containing chlorinated paraffin, magnesium dihyroxide (MDH), and zinc borate, with and without ATO. Formulations that include the yttrium hydroxide of example 1 show increased thermal stability and reduction of amount of ATO.

### Comparative Example 6A

### Polyvinyl Chloride Preparation with Chlorinated Paraffin, Magnesium Dihydroxide (MDH), and Zinc Borate

A two roll mill machine was loaded with Polyvinyl chloride resin (PVC resin k70), a plasticizer (diisononyl terephthalate (DINP)), a chlorinated paraffin (CP52 chlorinated paraffin 52% Cl), an inorganic flame retardant (Ecopiren 5.5C a natural MDH), a stabilizer (CaCO₃ omyacarb 2T-AV), a smoke suppressant (zinc borate), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.4 kg (40 phr), the chlorinated paraffin was 0.15 kg (15 phr), the MDH inorganic flame retardant 0.4 kg (40 phr), the CaCO₃ stabilizer was 0.4 kg (40 phr), the smoke suppressant was 0.04 kg (4 phr) and the calcium zinc stearate stabilizer was 0.05 kg (5 phr) for a total of 2.44 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.53 g/cm³. Hardness of the material was measured at 92. The Limiting Oxygen Index (LOI) was measured to be 24%. The CongoRed test resulted in 79 min. The UL94 classification was determined to be V-2.

### Comparative Example 6B

### Polyvinyl Chloride Preparation with Chlorinated Paraffin, Magnesium Dihydroxide (MDII), Zinc Borate, and Antimony Trioxide (ATO)

A two roll mill machine was loaded with Polyvinyl chloride resin (PVC resin k70), a plasticizer (diisononyl terephthalate (DINP)), a chlorinated paraffin (CP52 chlorinated paraffin 52% Cl), an inorganic flame retardant (Ecopiren 5.5C a natural MDH), a stabilizer (CaCO₃ omyacarb 2T-AV), a smoke suppressant (zinc borate), an inorganic flame retardant (antimony trioxide (ATO)), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.4 kg (40 phr), the chlorinated paraffin was 0.15 kg (15 phr), the MDH inorganic flame retardant 0.4 kg (40 phr), the CaCO₃ stabilizer was 0.4 kg (40 phr), the ATO inorganic flame retardant was 0.05 kg (5 phr), the smoke suppressant was 0.04 kg (4 phr) and the calcium zinc stearate stabilizer was 0.05 kg (5 phr) for a total of 2.49 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.54 g/cm³. Hardness of the material was measured at 92. The Limiting Oxygen Index (LOI) was measured to be 30%. The CongoRed test resulted in 82 min. The UL94 classification was determined to be V-0.

### Example 6A

### Polyvinyl chloride Preparation with Chlorinated Paraffin, Magnesium Dihydroxide (MDII), Zinc Borate, and Yttrium Hydroxide of Example 1

A two roll mill machine was loaded with Polyvinyl chloride resin (PVC resin k70), a plasticizer (diisononyl terephthalate (DINP)), a chlorinated paraffin (CP52 chlorinated paraffin 52% Cl), an inorganic flame retardant (Ecopiren 5.5C a natural MDH), a stabilizer (CaCO₃ omyacarb 2T-AV), a smoke suppressant (zinc borate), the yttrium hydroxide of example 1, and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.4 kg (40 phr), the chlorinated paraffin was 0.15 kg (15 phr), the MDH inorganic flame retardant 0.4 kg (40 phr), the CaCO₃ stabilizer was 0.4 kg (40 phr), the smoke suppressant was 0.04 kg (4 phr), the calcium zinc stearate stabilizer was 0.05 kg (5 phr), and the yttrium hydroxide of example 1 was 0.05 (5 phr) for a total of 2.49 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.54 g/cm³. Hardness of the material was measured at 93. The Limiting Oxygen Index (LOI) was measured to be 25%. The CongoRed test resulted in 101 min. The UL94 classification was determined to be V-2.

### Example 6B

### Polyvinyl Chloride Preparation with Chlorinated Paraffin, Magnesium Dihydroxide (MDH), Zinc Borate, Antimony Trioxide (ATO), and Yttrium Hydroxide of Example 1

A two roll mill machine was loaded with Polyvinyl chloride resin (PVC resin k70), a plasticizer (diisononyl terephthalate (DINP)), a chlorinated paraffin (CP52 chlorinated paraffin 52% Cl), an inorganic flame retardant (Ecopiren 5.5C a natural MDH), a stabilizer (CaCO₃ omyacarb 2T-AV), a smoke suppressant (zinc borate), an inorganic flame retardant (antimony trioxide (ATO)), the yttrium hydroxide of example 1, and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.4 kg (40 phr), the chlorinated paraffin was 0.15 kg (15 phr), the MDH inorganic flame retardant 0.4 kg (40 phr), the CaCO₃ stabilizer was 0.4 kg (40 phr), the ATO inorganic flame retardant was 0.025 kg (2.5 phr), the smoke suppressant was 0.04 kg (4 phr), the calcium zinc stearate stabilizer was 0.05 kg (5 phr), and the yttrium hydroxide of example 1 was 0.025 kg (2.5 phr) for a total of 2.49 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.53 g/cm³. Hardness of the material was measured at 91. The Limiting Oxygen Index (LOI) was measured to be 30%. The CongoRed test resulted in 102 min. The UL94 classification was determined to be V-0.

TABLE 6
Components and measurements from Example 6

| | Comparative | Comparative | | |
|---|---|---|---|---|
| | Example 6A | Example 6B | Example 6A | Example 6B |
| PVC resin k70(phr) | 100 | 100 | 100 | 100 |
| DINP (phr) | 40 | 40 | 40 | 40 |
| CP52 chlorinated paraffin 52% Cl (phr) | 15 | 15 | 15 | 15 |
| Ecopiren 5.5 (MDH) (phr) | 40 | 40 | 40 | 40 |
| ATO (phr) | — | 5 | — | 2.5 |
| Yttrium hydroxide (phr) | — | — | 5 | 2.5 |
| CaCO₃ | 40 | 40 | 40 | 40 |
| Zinc Borate (phr) | 4 | 4 | 4 | 4 |
| Stab Ca/Zn CBS 209/7 (phr) | 5 | 5 | 5 | 5 |
| Total (phr) | 244 | 249 | 249 | 249 |
| Density | 1.53 | 1.54 | 1.54 | 1.53 |
| Hardness Shore A | 92 | 92 | 93 | 91 |
| Limiting Oxygen Index | 24 | 30 | 25 | 30 |
| CongoRed@200° C. (min) | 79 | 82 | 101 | 102 |
| UL94 classification | V-2 | V-0 | V-2 | V-0 |

### Comparative Example 7

The following examples compare PVC formulations containing chlorinated paraffin and increasing amounts of ATO. The results show the UL94 rating correlates with increased amounts of ATO present. These examples contain no rare earth compound and require increased amounts of ATO in comparison to the examples with rare earth compound to have desirable UL94 ratings. Chlorinated paraffins also may be considered undesirable as described herein.

Comparative Example 7A. Polyvinyl chloride preparation with chlorinated paraffin

A two roll mill machine was loaded with Polyvinyl chloride resin (PVC resin k70), a plasticizer (diisodecyl phthalate (DIDP)), a chlorinated paraffin (Essebiochlor 45), a stabilizer (CaCO₃ omyacarb 2T-AV), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.35 kg (35 phr), the CaCO₃ stabilizer was 0.5 kg (50 phr), the chlorinated paraffin was 0.15 kg (15 phr), and the calcium zinc stearate stabilizer was 0.03 kg (3 phr) for a total of 2.03 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.448 g/cm³. Hardness of the material was measured at 88. The Limiting Oxygen Index (LOI) was measured to be 24%. The CongoRed test resulted in 34 min. The UL94 classification was not classifiable. The Color stability test showed significant darkening.

### Comparative Example 7B

### Polyvinyl Chloride Preparation with Chlorinated Paraffin

A two roll mill machine was loaded with Polyvinyl chloride resin (PVC resin k70), a plasticizer (diisodecyl phthalate (DIDP)), a chlorinated paraffin (Essebiochlor 45), a stabilizer (CaCO₃ omyacarb 2T-AV), an inorganic flame retardant (antimony trioxide (ATO)), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.35 kg (35 phr), the CaCO₃ stabilizer was 0.5 kg (50 phr), the chlorinated paraffin was 0.15 kg (15 phr), the ATO inorganic flame retardant was kg (3 phr), and the calcium zinc stearate stabilizer was 0.03 kg (3 phr) for a total of 2.06 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.469 g/cm³. Hardness of the material was measured at 89. The Limiting Oxygen Index (LOI) was measured to be 29%. The CongoRed test resulted in 38 min. The UL94 classification was determined to be V-2. The Color stability test showed less darkening than comparative example 7A.

### Comparative Example 7C

### Polyvinyl Chloride Preparation with Chlorinated Paraffin

A two roll mill machine was loaded with Polyvinyl chloride resin (PVC resin k70), a plasticizer (diisodecyl phthalate (DIDP)), a chlorinated paraffin (Essebiochlor 45), a stabilizer (CaCO₃ omyacarb 2T-AV), an inorganic flame retardant (antimony trioxide (ATO)), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.35 kg (35 phr), the CaCO₃ stabilizer was 0.5 kg (50 phr), the chlorinated paraffin was 0.15 kg (15 phr), the ATO inorganic flame retardant was kg (6 phr), and the calcium zinc stearate stabilizer was 0.03 kg (3 phr) for a total of 2.09 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.478 g/cm³. Hardness of the material was measured at 90. The Limiting Oxygen Index (LOI) was measured to be 31%. The CongoRed test resulted in 38 min. The UL94 classification was determined to be V-2. The Color stability test showed less darkening than comparative example 7B.

### Comparative Example 7D

### Polyvinyl Chloride Preparation with Chlorinated Paraffin

A two roll mill machine was loaded with Polyvinyl chloride resin (PVC resin k70), a plasticizer (diisodecyl phthalate (DIDP)), a chlorinated paraffin (Essebiochlor 45), a stabilizer (CaCO₃ omyacarb 2T-AV), an inorganic flame retardant (antimony trioxide (ATO)), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.35 kg (35 phr), the CaCO₃ stabilizer was 0.5 kg (50 phr), the chlorinated paraffin was 0.15 kg (15 phr), the ATO inorganic flame retardant was kg (9 phr), and the calcium zinc stearate stabilizer was 0.03 kg (3 phr) for a total of 2.12 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.496 g/cm³. Hardness of the material was measured at 90. The Limiting Oxygen Index (LOI) was measured to be 29%. The CongoRed test resulted in 40 min. The UL94 classification was determined to be V-0. The Color stability test showed less darkening than comparative example 7C.

### Comparative Example 7E

### Polyvinyl Chloride Preparation with Chlorinated Paraffin

A two roll mill machine was loaded with Polyvinyl chloride resin (PVC resin k70), a plasticizer (diisodecyl phthalate (DIDP)), a chlorinated paraffin (Essebiochlor 45), a stabilizer (CaCO₃ omyacarb 2T-AV), an inorganic flame retardant (antimony trioxide (ATO)), and a stabilizer (Stab Ca/Zn CBS 209/7 a calcium zinc stearate). The amounts of each component can be adjusted for the desired properties of the resulting PVC. In this example the polyvinyl chloride content was 1 kg (100 phr), the plasticizer was 0.35 kg (35 phr), the CaCO₃ stabilizer was 0.5 kg (50 phr), the chlorinated paraffin was 0.15 kg (15 phr), the ATO inorganic flame retardant was 0.12 kg (12 phr), and the calcium zinc stearate stabilizer was 0.03 kg (3 phr) for a total of 2.15 kg PVC compound produced. The rolls are heated to approximately 150° C. The materials are mixed for 5 minutes to produce sheets with a thickness of 0.8 mm. The sheets were allowed to cool to room temperature. The resulting PVC compound sheets were tested for density and found to be 1.511 g/cm³. Hardness of the material was measured at 91. The Limiting Oxygen Index (LOI) was measured to be 29%. The CongoRed test resulted in 40 min. The UL94 classification was determined to be V-0. The Color stability test showed less darkening than comparative example 7D.

TABLE 7
Components and measurements from Example 7

| | Comparative | Comparative | Comparative | Comparative | Comparative |
|---|---|---|---|---|---|
| | Example 7A | Example 7B | Example 7C | Example 7D | Example 7E |
| PVC resin k70 (phr) | 100 | 100 | 100 | 100 | 100 |
| DIDP (phr) | 35 | 35 | 35 | 35 | 35 |
| Essebiochlor 45 | 15 | 15 | 15 | 15 | 15 |
| CaCO₃ omyacarb 2T-AV | 50 | 50 | 50 | 50 | 50 |
| (phr) | | | | | |
| ATO (phr) | — | 3 | 6 | 9 | 12 |
| Stab Ca/Zn CBS 209/7 | 3 | 3 | 3 | 3 | 3 |
| (phr) | | | | | |
| Total (phr) | 203 | 206 | 209 | 212 | 215 |
| Density | 1.448 | 1.469 | 1.478 | 1.496 | 1.511 |
| Hardness Shore A | 88 | 89 | 90 | 90 | 91 |
| Limiting Oxygen Index | 24 | 29 | 31 | 29 | 29 |
| CongoRed@200° C. | 34 | 38 | 38 | 40 | 40 |
| (min) | | | | | |
| UL94 classification | Not classifiable | V-2 | V-2 | V-0 | V-0 |
| Color Stability | Darkest | Less than | Less than | Less than | Lightest |
| | | 7A | 7B | 7D | |

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A polyvinyl chloride (PVC) composition comprising:
PVC resin;
an inorganic flame retardant selected from the group consisting of antimony trioxide (ATO), magnesium dihydroxide (MDH), aluminum trihydrate (ATH), and mixtures thereof; and
a rare earth compound selected from the group consisting of rare earth hydroxides, hydrated rare earth oxides, and mixtures thereof;
wherein the composition comprises 100 phr of PVC resin and has a UL94 classification with a sample thickness of about 0.8 mm of V-2 or higher.

2. The PVC composition of claim 1 comprising about 1 phr to about 10 phr rare earth compound.

3. The PVC composition of claim 1, wherein the rare earth compound is yttrium hydroxide, lanthanum hydroxide, cerium hydroxide, neodymium hydroxide, praseodymium hydroxide, hydrated yttrium oxide, hydrated lanthanum oxide, hydrated cerium oxide, hydrated neodymium oxide, hydrated praseodymium oxide, or mixtures thereof.

4. The PVC composition of claim 1, wherein the inorganic flame retardant is antimony trioxide (ATO), magnesium dihydroxide (MDH), or a mixture thereof.

5. The PVC composition of claim 1, wherein the inorganic flame retardant is ATO and the PVC composition contains less ATO than in a PVC composition not containing the rare earth compound to achieve the same UL94 classification.

6. The PVC composition of claim 5, wherein the rare earth compound is yttrium trihydroxide, lanthanum hydroxide, or a mixture thereof, and the ratio of ATO:rare earth compound is about 1:3 to about 3:1.

7. The PVC composition of claim 6, wherein the ratio of ATO:rare earth compound is about 1:1.

8. The PVC composition of claim 6, wherein the composition comprises ATO and rare earth compound collectively in an amount of about 3 phr to about 10 phr.

9. The PVC composition of claim 8, wherein the composition comprises about 1 to about 3.5 phr ATO and about 1 to about 3.5 phr rare earth compound.

10. The PVC composition of claim 1, wherein the PVC composition has a UL94 classification with a sample thickness of 0.8 mm of V-0, V-1, or V-2.

11. The PVC composition of claim 1, further comprising an additive selected from the group consisting of fillers, plasticizers, colorants, stabilizers, lubricants, organic flame retardants, smoke suppressants, and mixtures thereof.

12. The PVC composition of claim 5 comprising about 0 phr chlorinated paraffins.

13. The PVC composition of claim 1, wherein the PVC composition has a CongoRed at 200° C. of about 90 mins to about 200 mins.

14. The PVC composition of claim 1, wherein the composition has a limiting oxygen index of about 20 to about 35.

15. A PVC composition comprising:
PVC resin; ATO; and a rare earth hydroxide comprising Y(OH)₃, La(OH)₃, or a mixture thereof;
wherein the PVC composition comprises 100 phr of PVC resin and comprises ATO and rare earth hydroxide collectively in an amount of about 3 phr to about 10 phr,
wherein the PVC composition has a UL94 classification with a sample thickness of 0.8 mm of V-0, V-1, or V-2, and the PVC composition contains less ATO than in a PVC composition not containing the rare earth hydroxide to achieve the same UL94 classification.

16. The PVC composition of claim 15, comprising about 0 phr chlorinated paraffins.

17. The PVC composition of claim 15, further comprising an additive selected from the group consisting of fillers, plasticizers, colorants, stabilizers, lubricants, organic flame retardants, smoke suppressants, and mixtures thereof.

18. A PVC composition comprising:
100 phr PVC resin;
about 25 phr to about 50 phr MDH; and
about 3 phr to about 10 phr rare earth hydroxide, wherein the rare earth hydroxide comprises Y(OH)₃, La(OH)₃, or a mixture thereof;
wherein the PVC composition has a UL94 classification with a sample thickness of mm of V-0, V-1, or V-2.

19. The PVC composition of claim 18, comprising about 0 phr ATO.

20. The PVC composition of claim 18, further comprising an additive selected from the group consisting of fillers, plasticizers, colorants, stabilizers, lubricants, organic flame retardants, smoke suppressants, and mixtures thereof.
